(19) United States
(12) Patent Application Publication
(10) Pub. No.: US 2019/0283161 A1
(43) Pub. Date: Sep. 19, 2019

(54) SUBSTRATE PLATE PREPARATION FOR USE IN ADDITIVE MANUFACTURING IN CUT-MACHINING AND GRINDING ENVIRONMENT

(71) Applicant: Tytus3D System Inc., Fremont, CA (US)

(72) Inventors: Jerald YUN, Pleasanton, CA (US); Ilgoo HWANG, San Jose, CA (US); Hon S. YI, San Jose, CA (US)

(73) Assignee: Tytus3D System Inc.

(21) Appl. No.: 16/357,317

(22) Filed: Mar. 18, 2019

Related U.S. Application Data
(60) Provisional application No. 62/644,704, filed on Mar. 19, 2018.

(51) Int. Cl. B23H 11/00; B23H 5/04; B29C 64/379; B23D 53/06; B23Q 3/16

(52) U.S. Cl. CPC B23H 11/003; B23H 5/04; B29C 64/379; B33Y 40/00; B23Q 3/16; B23H 2500/20; B23D 53/06

(57) ABSTRACT

A system for removing one or more three-dimensional workpieces manufactured in additive manufacturing environment from a substrate plate is disclosed. The system includes an adjustable support tooling apparatus, a grinder, a cut-machining device, a work tank, a wire discharge machine and coolant pump filtration system. The adjustable support tooling apparatus is supporting a three-dimensional workpiece while it is being detached from a substrate plate by cutting device. The adjustable support apparatus of the present disclosure is also easily adaptable to various weights and geometric of workpiece. The improved substrate plate preparation machine in additive manufacturing enables to complete a job at one place, wherein the job is cutting the work piece and grinding the uneven cut surface of the substrate plate, thereby the ground substrate plate can be reused.

### CROSS-REFERENCE TO A RELATED APPLICATION

This application is a nonprovisional of claims the benefit of and priority to U.S. Provisional Patent Application No. 62/644,704, filed Mar. 19, 2018, inventors Ilgoo Hwang et al., titled “SUBSTRATE PLATE PREPARATION SYSTEM IN ADDITIVE MANUFACTURING”, which is commonly assigned herewith, and all of which is hereby incorporated herein by reference in its entirety with the same full force and effect as if set forth in its entirety herein.

### FIELD OF THE INVENTION

The present disclosure generally relates to substrate plate preparation machine, more particularly, to remove various dimensional workpieces from a substrate and to grind surface thereto.

### BACKGROUND OF THE INVENTION

Additive Manufacturing, also referred to as three-dimensional printing, is a technology that produces three-dimensional workpieces layer by layer, be it polymer or metal based. A powder deposition method is one of a representative use in additive manufacturing system, and it has a coating mechanism to distribute a powder layer onto a substrate plate (as known as a build plate) and a powder reservoir (also known as a powder bed). In a powder-bed-fusion method, for example, as laser scans onto the deposited powder layer to fabricate a desired workpiece, the deposited powder gets melted and become firmly fixed onto the substrate plate until the workpiece is completely manufactured. The substrate plate can be re-used for another work after cutting out the manufactured workpiece stick to the substrate plate.

Conventional cutting method is using a wire-cut electric discharge machining (EDM) or a band saw to detach the manufactured workpiece from the substrate plate, and it usually takes longer due to the large number of reservations, if it is asked to the third party or outside source, such as a professional cutting and milling agency. Even though it is operated internally, it is inconvenient to operate a conventional cutting machine, such as computer numerical control (CNC) machine, due to its complicated operation. Therefore, the CNC machine requires an experienced and skilled operator for its usage, and the CNC machine is also expensive.

Additionally, there are many operations within the manufacturing environment that require workpieces to be well supported while operations are being performed on it. Accordingly, there may be undesired damages to other parts of the workpiece or to the wire, when the previously cut part is falling down, or unnecessary movements while the workpiece is being cut by wire EDM. Meanwhile, using a customized solid foam to fixture the workpieces not only may contaminate the workpiece, but also may waste time and materials, since the solid foam must be prepared for every new operation.

It would be beneficial to provide an all-in-one cutting machine including a grinder, and to provide a support fixture that stably support the three-dimensional workpieces while the workpiece is being detached off the substrate plate.

### SUMMARY OF THE INVENTION

The present disclosure of the invention will provide numerous advantages. A representative embodiment of a substrate preparation system is disclosed generally comprising an adjustable support apparatus having a base with a plurality of pins movable along a plurality of longitudinal lumens inside, a cut-machining device, a coolant reservoir, filtration and pumping system, and a grinder mounted on a gantry. An aspect of one embodiment of the invention is to provide a system for cutting and grinding a three-dimensional workpiece from a substrate plate at one place by employing a plurality of pins stably supporting the manufactured three-dimensional workpieces. Accordingly, an embodiment of a substrate preparation system may quickly and uniformly support a desired workpiece manufactured at different dimensions during cutting, without preparing a customized supporter. The all-in-one machine for the cutting and grinding at one place has the advantages of being convenient, charging less space, light in weight, economic manufacturing cost and operation, easy operation and the like.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a schematic isometric view of an embodiment of an adjustable support apparatus for substrate plate preparation,

FIG. 2 is an isometric view showing the adjustable support apparatus in the activated position,

FIG. 3A is a cross sectional view of the adjustable support apparatus in the activated position,

FIG. 3B is another exemplary of a cross sectional view of the adjustable support apparatus in the activated position,

FIGS. 4A and 4B are enlarged, partial, perspective views of an embodiment of a second pin cap in adjustable support apparatus,

FIG. 5 is an exploded perspective view of a pin holder of the adjustable support apparatus with a pin cap and a locking mechanism,

FIG. 6 is a partial cross sectional view of the adjustable support apparatus with a pin cap and a locking mechanism,

FIG. 7 is a schematic isometric view of an embodiment of a substrate plate preparation system in additive manufacturing,

FIG. 8 is a schematic isometric view of the embodiment of a substrate plate preparation system in additive manufacturing, and

FIG. 9 is a schematic cross sectional view of the embodiment of a substrate plate preparation system in additive manufacturing.

### DETAILED DESCRIPTION OF REPRESENTATIVE EMBODIMENTS

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

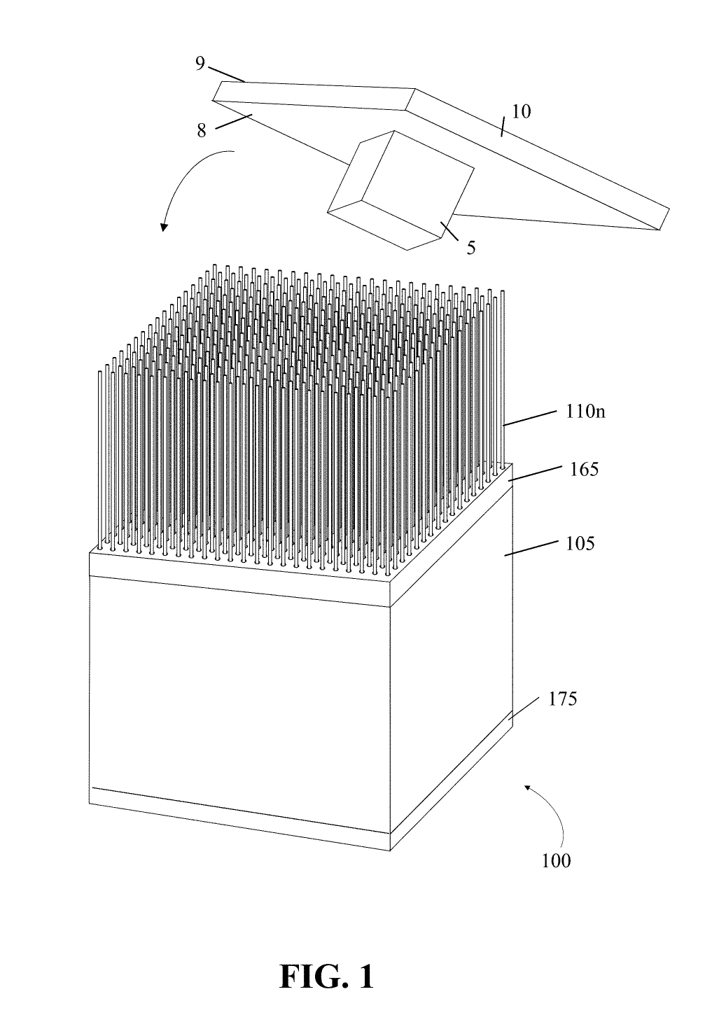

The present invention is a substrate preparation system for a use in additive manufacturing environment. In the disclosed embodiment, In the disclosed embodiment, a system of removing a workpiece having various dimensions manufactured in additive manufacturing environment, and grinding the detached surface at one place is provided. One embodiment of the present invention relates to a system to remove a metal based component having a heavy weight, without secondary damage due to unnecessary movement during the cutting process, an adjustable support apparatus for stably supporting the heavy component is provided. Accordingly, an exemplary embodiment of a substrate preparation system having a plurality of pins may evenly support workpieces of different dimensions each time without preparing a customized supporter. FIGS. 1 to 9 illustrate various implementations of the substrate plate preparation system associated with the present disclosure.

FIG. 1 is a schematic isometric view of an embodiment of an adjustable support apparatus for substrate plate preparation. The adjustable support apparatus 100 is used to support a three-dimensional workpiece 5, be it metal based or polymer, during its detaching operation from a substrate plate 10 using a cut-machining device, such as, wire-cut electrical discharge machine or band-saw machine. Generally, in additive manufacturing environment, the desired workpiece (or part) is stick to the substrate plate during the manufacturing process. The completed one or more built up workpieces 5 should be removed, and the substrate plate surface 8 should be ground for reuse.

An adjustable support apparatus 100 has a base 105, a plurality of pins 110n on top, an upper base 165 and a lower base 175, as shown in FIG. 1 In the exemplary embodiment, a substrate plate 10 having three-dimensional work pieces 5 is placed on top of the adjustable support apparatus 100 with the manufactured workpieces 5 facing downward, i.e., with the bottom surface 9 of the substrate plate 10 facing up. This prevents unnecessary movements of the workpiece 5 while being cut from the substrate plate, since the adjustable support apparatus 100 is evenly holding the workpiece 5.

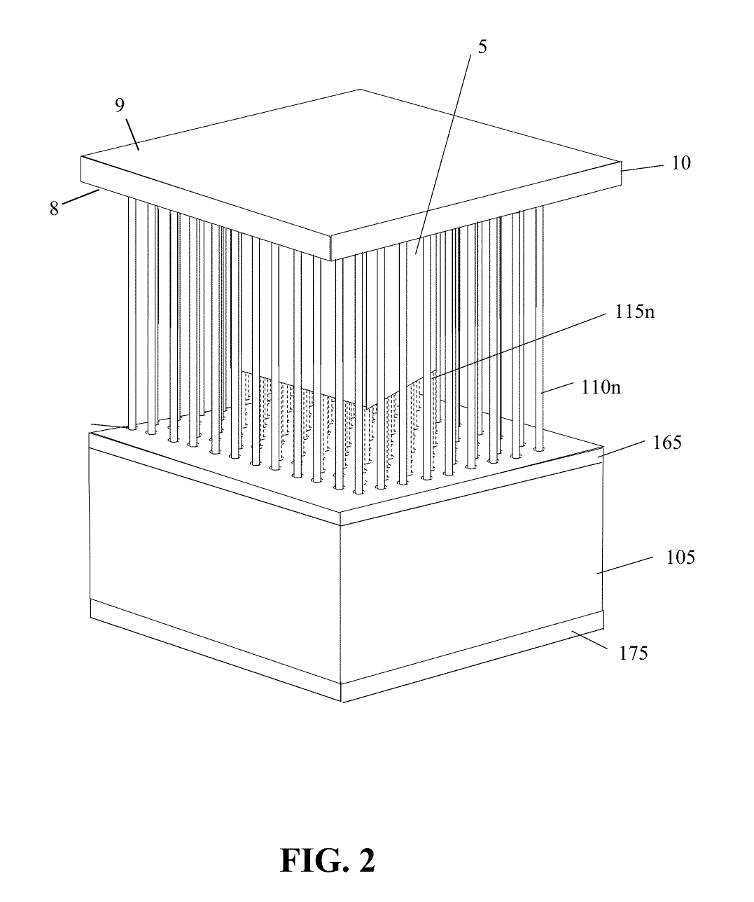

In some implementations, some pins that comes into contact with the workpiece 5 may go down by that volume. An isometric view illustrating the adjustable support apparatus 100 in the activated position is shown in FIG. 2.

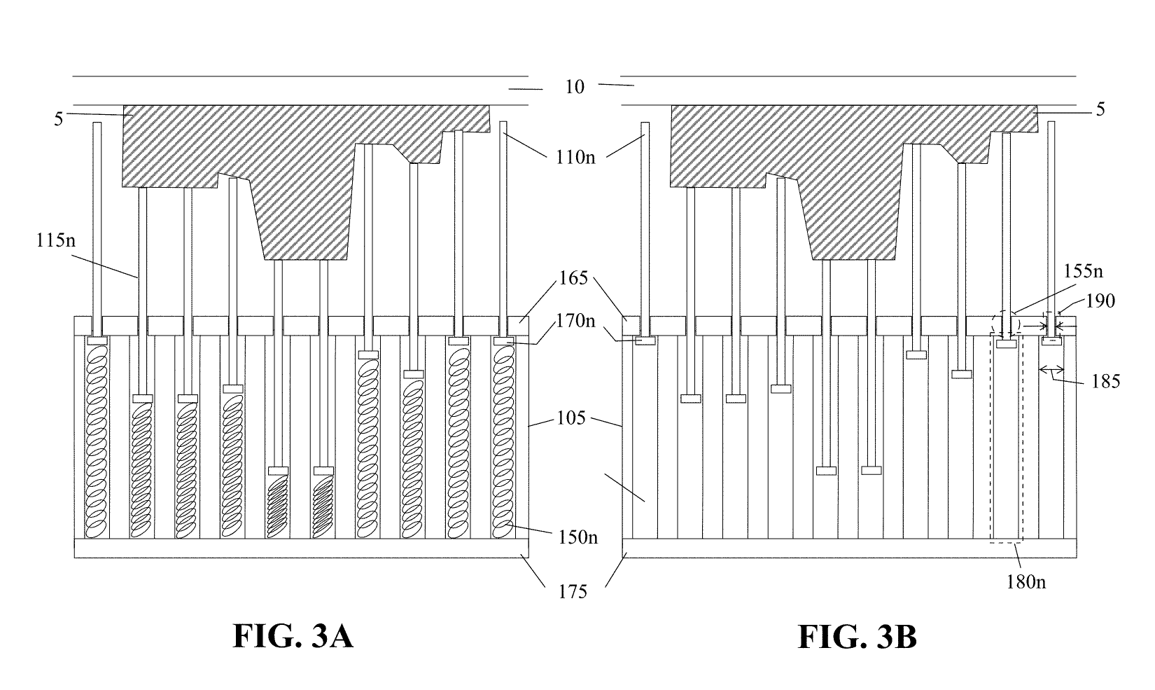

FIGS. 3A and 3B are cross sectional views of the adjustable support apparatus 100 in the activated position. The adjustable support apparatus 100 has a plurality of lumens 180n that vertically extended to the end of the base 105. Each lumen has a first diameter 185 which each pin 110n can pass. In the exemplary embodiment, the upper base has open ends 155n on top and bottom at a second diameter 190. Thus, the open end 155n of the upper base 165 and the open end of the lumen 180n of the base 105 are connected to each other, thereby a pin 110n may be movable along the internal passageway formed within the adjustable support apparatus 100. The disclosed embodiment has a first end cap 170n at the bottom of the pin 110n, wherein the pin 110n and the first end cap 170n may be coupled through a thread, fused or adhesively bonded, but not limited to. In some instances, the plurality of lumens of the base may be filled with a spring as shown in FIG. 3A. In another embodiment of the disclosure, as shown in FIG. 3B, the lumens may be filled with compressed air, but not limited to. The compressed air may be actuated by electronic manipulations. In a representative embodiment, the pin may be in an extended position because the spring supports the pin cap when there is no pressure from the top. Additionally, the pin may be in an activated position (or retracted position) when there is no pressure from the top, and the retracted position may not further below due to the spring. In some instances, the second diameter 190 is narrower than that of the first end cap 170n, thereby the pin 110n may remain at the extended position without escaping the base 105. In this embodiment, the pins that contact with the workpieces 115n are being activated to go down along a longitudinal lumen 180n of the adjustable support apparatus 100 due to its three-dimensional volume, as described above. In this embodiment, each of the pin 110n is independently movable along the lumen.

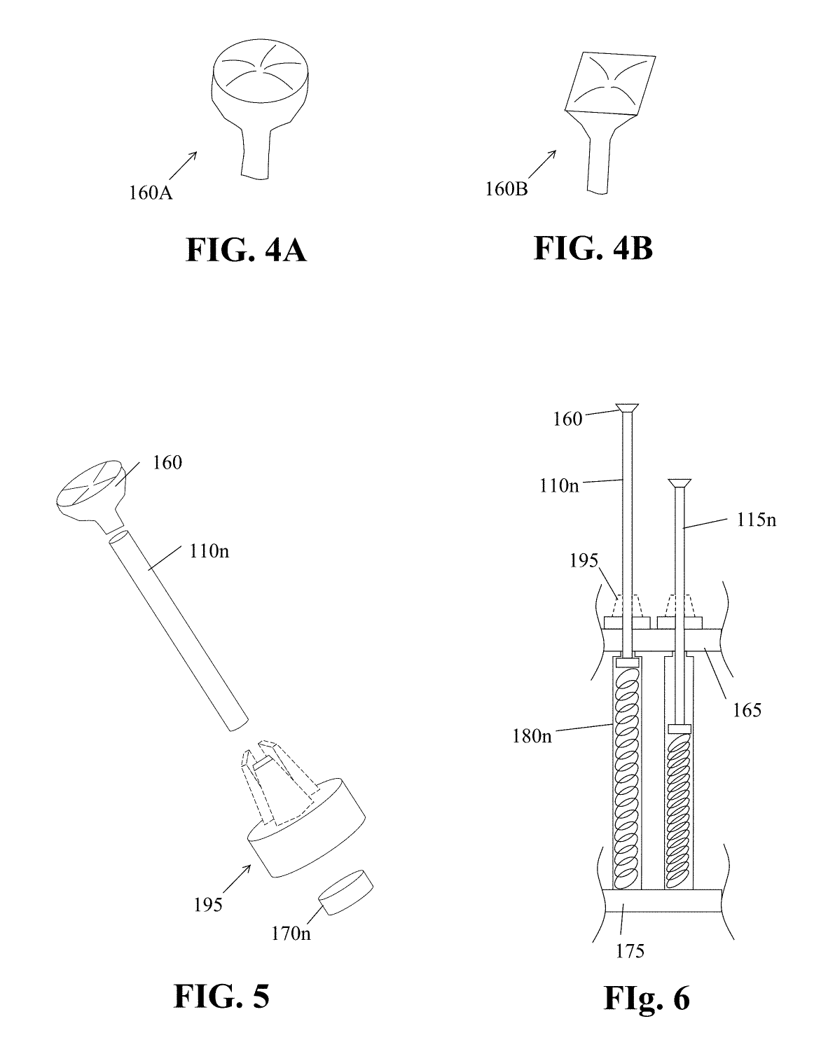

FIGS. 4A and 4B are enlarged, partial, perspective views of an embodiment of a second end cap associated with a pin of the adjustable support apparatus. The pin 110n may have a second end cap 160, such as a rounded shape 160A or an angled shape 160B, on the top of the pin. In some instances, the second pin cap 160 may be coupled through threaded, fused, adhesively bonded, or assembled, but not limited to. Each cap 160 may provide wider coverage to support the workpiece 5, thereby the workpiece 5 may be sustainably remain during the cutting process.

FIG. 5 is an exploded perspective view of a pin holder of the adjustable support apparatus with pin caps and a locking mechanism (or work holding device). When a pin 110n is in activated position, there may be further movement during the cutting process. It is necessary to fix the pin 110n to prevent further movement. In the disclosed embodiment, a locking mechanism using work holding device 195 may be employed. The work holding device 195 may be installed on the upper base 165 to fix the pin in an activated (or retracted) position, wherein the holding device may have one or more jaws to grip the pin on the upper base surface 165. Optionally, the work holding device 195 may be installed within the lumen 180n of the base 105, but not limited to. Additionally, the work holding device 195 may be activated quickly when noticed that the at least one pin is in an activated position. For example, the work holding device may be collets, or chuck in various type, such as in self-centering, four jaw independent, combination, air operated, or soft jaw, but not limited to. In some implementations, the work holding device may be actuated in automatically or manually through a controller.

FIG. 6 is a partial cross sectional view of an exemplary adjustable support apparatus with a pin cap and a locking mechanism. When the pin having a first end cap and a second end cap is in an activated position 115n, in some instances, the locking mechanism 195 installed on the top upper base 165 configured to grip the pin 115n may be activated quickly, either manual or in automatic. In the exemplary embodiment, the locking mechanism may act on all pins in an extended position and a retracted position at the same time.

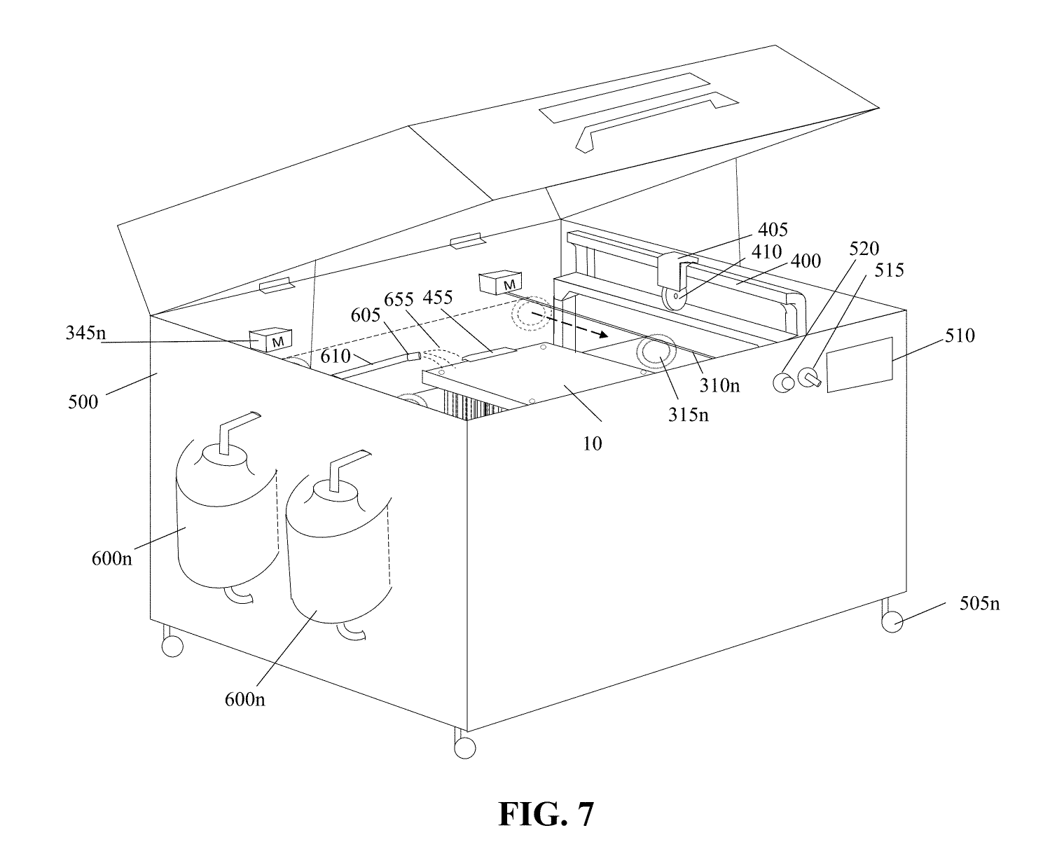

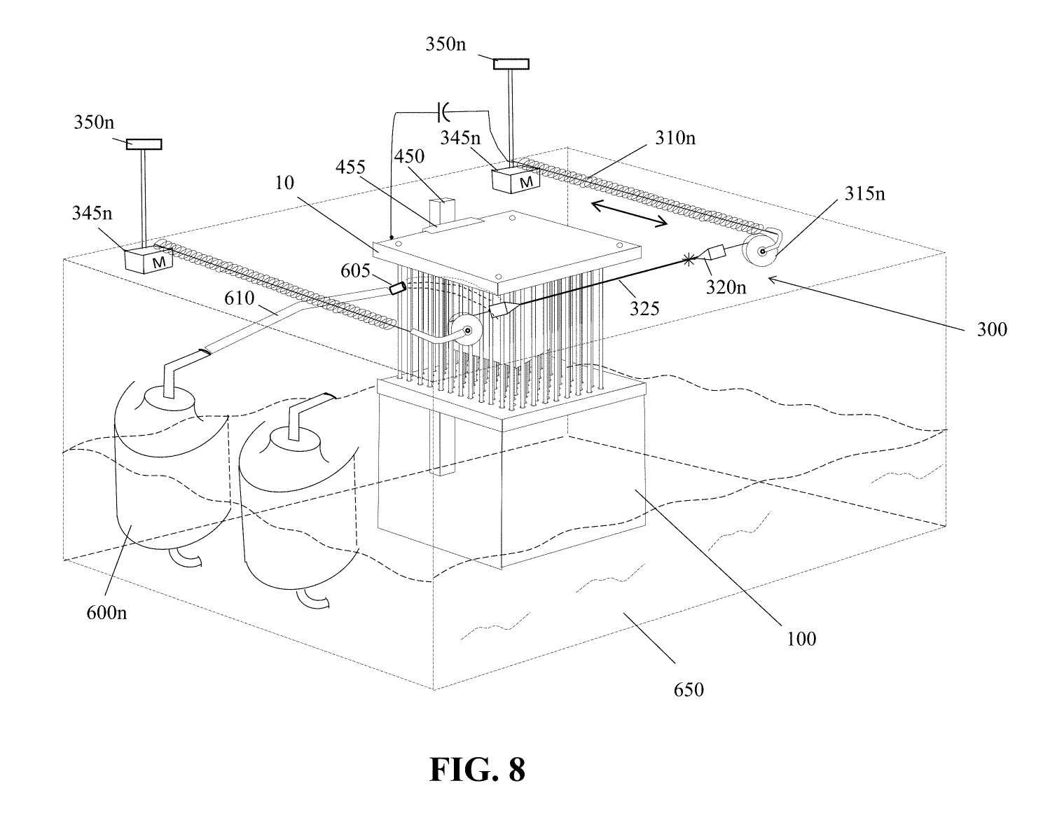

FIGS. 7 to 8 are schematic isometric views of a system for removing three-dimensional workpiece from a substrate and grinding the detached surface according to an exemplary embodiment. The adjustable support apparatus 100 is mounted on a work tank 500, wherein the work tank 500 includes a cut-machining device 300 (such as a wire-cut electrical discharge machining (EDM), die-sink EDM or a band saw, but not limited to), a substrate plate holder 455, an end mil 410 mounted gantry 400, and a coolant pumping and filtration system 600n along with a controller 510, 515, and 520. In the exemplary embodiment, the work tank is filled with dielectric fluid (or liquid) 650. The substrate plate holder 455 is vertically movable along a work frame 450, it may be adjusted to the appropriate position according to the fabricated workpieces 5 volume. When a three-dimensional workpiece 5 is placed on an adjustable support apparatus 100 in the work tank 500, the coolant pumping and filtration system 600n and the cut-machining device 300 may be activated via a controller 510, 515, and 520. For example, the controller may include a power switch 515, pause/resume switch 520, a control panel with simple user interface (or a touch display screen with user interface) 510. In representative embodiment, the cut-machining device 300 (e.g., wire-cut EDM) is initiated via powering up with the switch 515 and operating drivers 350n and motors 345n connected along with one or more wire rollers 315n and electrodes 320n, wherein the motors 345n configured to control the electrodes 320n movement through wire rollers 315n on lead screws 310n. When the voltage between the two electrodes 320n is increased, the intensity of the electric field in the volume between the electrodes 320n becomes greater than the strength of the dielectric, which breaks down, allowing current to flow 325 between the two electrodes 320n. Consequently, the part 5 (or workpiece) is being removed from the electrodes 320n. In some instances, the copper line may be replaced to copper-tungsten, or tungsten carbide electrodes, but not limited to. The pair of lead screws 310n coupled to a pair of motors 345n are fixed to the wall of the work tank 500, and the motors 345n are connected with a pair of drivers 350n and power supplies 515.

Additionally, a grinder 410 is installed on the gantry 400 associated with the holder 405. In representative embodiment, once the workpiece 5 is removed from the substrate plate 10, the surface of the substrate plate needs to be ground to have an evenly flat surface. Accordingly, it can be reused for another additive manufacturing process.

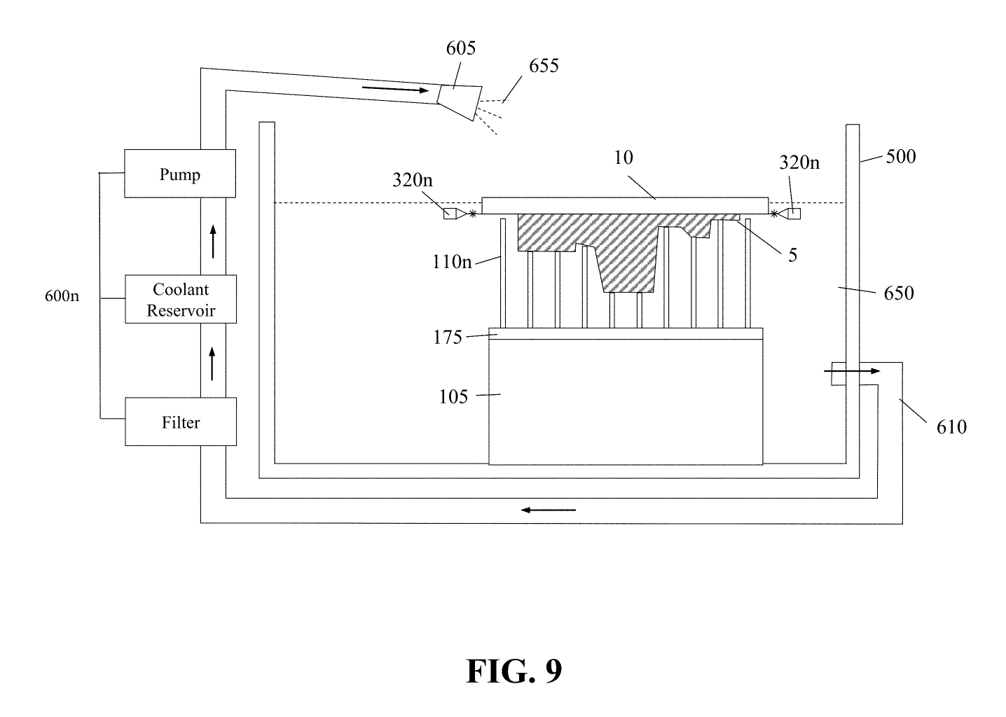

FIG. 9 is a schematic cross-sectional view of the embodiment of a substrate plate preparation system. A coolant reservoir and filtration system 600n is installed to the system, i.e., a work tank 500. Once the current stops, new dielectric fluid 655 is usually conveyed 610 into between the electrode 320n and a workpiece 5, i.e., flushing, enabling the solid particles to be carried away and the insulating properties of the dielectric to be restored. A coolant tank 600n (also referred to a coolant reservoir and filtration system) having an inlet fluidly connected to the fluid 650 of the work tank 500 and an outlet fluidly connected to the flushing nozzle 605, wherein the system 600n is configured to recirculate the flushing fluid 655 from the coolant system 600n, through the work tank 500, and back to the coolant system 600n.

Other aspects and embodiments of the present invention may be obvious having viewed this particular detailed description of the present invention. However, this detailed description is intended to be educational and instructive and is not intended to be limiting upon the scope and content of the following claims. For example, the system the adjustable support apparatus 100 may have configurations other than the embodiments of the support apparatus 100 shown in FIGS. 1-9. In alternate embodiments (not shown), the adjustable support apparatus 100 may not have a base 105 with a plurality of slidably movable pins 110n, or may be replaced with conventional supporter having an x-motor and a y-motor for use in cut-machining device 300. Also, the cut-machining device 300 may have configurations other than the embodiments of the cut-machining device 300 shown in FIGS. 7-9. Accordingly, the invention is not limited except as by the appended claims.

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

“optional” or “optionally” means that the subsequently described event or circumstance may or may not occur, and that the description includes instances where the event occurs and instances where it does not.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A system for removing one or more three-dimensional workpieces from a substrate plate, and preparing a substrate plate for use in additive manufacturing environment, the system comprising:
an adjustable support apparatus configured to hold up one or more workpieces having various dimensions melted and stuck on a substrate plate;
an adjustable substrate plate holder having a fixture, wherein the fixture holds the substrate plate and the adjustable substrate plate holder vertically moves along a framework;
a coolant pumping and filtration system having a nozzle coupled to a pumping system configured to jet dielectric fluid to the three-dimensional workpiece;
a cut machining device coupled to one or more rollers;
a controller configured to control the adjustable support apparatus and the cut machining device operations; and
a gantry having an end mil configured to grind surface of the substrate plate after the three-dimensional workpieces detached from the substrate plate.

2. The system of claim 1, wherein the adjustable support apparatus further comprises:
a base having a plurality of longitudinal lumens with a first diameter and an open end, wherein the base is coupled to an upper base having a second diameter and open passages, and further coupled to a lower base having a solid body at the bottom;
a plurality of adjustable pins having longitudinal body, a distal end which moves along the longitudinal lumen and a first end cap at the bottom;
a plurality of fillers within the longitudinal lumens configured to allow the plurality of pins to move along the longitudinal lumens; and
a locking mechanism configured to hold the activated adjustable pins.

3. The system of claim 2, wherein the longitudinal lumens comprising a hexagonal body or cylindrical body.

4. The system of claim 2, the open end of the upper base and the open end lumen of the base are connected to each other, thereby the pin moves along the internal passageway formed within the adjustable support apparatus.

5. The system of claim 2, wherein the second diameter of the upper base is narrower than the first end cap.

6. The system of claim 2, wherein the locking mechanism further comprises a work holding device in a chuck or a collet type.

7. The system of claim 2, wherein the pin further comprises a second end cap at the top of the pin in round type or angled corner type which dimension is greater than that of the pin.

8. The system of claim 2, wherein the filler further comprises a spring based apparatus or a compressed air based apparatus.

9. The system of claim 8, wherein the spring based apparatus having a lower portion fixed to the lower base of the adjustable support apparatus and the upper portion fixed to the pin.

10. The system of claim 8, wherein the compressed air based apparatus having an electrical manual operation.

11. The system of claim 1, when the one or more three-dimensional workpieces attached to the substrate plate is placed on the plurality of pins of the adjustable support apparatus with the bottom surface of the substrate plate facing up, the substrate plate is fixed to adjustable substrate plate holder allows the plurality of pins are spaced apart from the upper surface of the substrate plate.

12. The system of claim 1, wherein the cut machining device further comprises an electrical discharge machining device having one or more electrodes wherein the electrodes generate current to flow between them by increasing voltage between them.

13. The system of claim 1, wherein the coolant pumping and filtration system further comprising:
a filtration system,
a coolant reservoir, and
a pumping system.

14. The system of claim 1, wherein the cut-machining device further comprises an electrode, or a band saw system.
